(19) United States
(12) Patent Application Publication
(10) Pub. No.: US 2007/0106629 A1
(43) Pub. Date: May 10, 2007

(54) System and method for accessing data

(76) Inventors: Steve Endacott, London (GB); Dominic North, London (GB); Paul Rutkowski, London (GB); Frank Sattler, London (GB); Tony Sceales, London (GB)

Correspondence Address: DICKSTEIN SHAPIRO LLP, 1825 EYE STREET NW, Washington, DC, 20006-5403, US

(21) Appl. No.: 11/250,624

(22) Filed: Oct. 17, 2005

(51) Int. Cl. G06N 5/02

(52) U.S. Cl. 706/47

(57) ABSTRACT

A method is disclosed for accessing data stored in at least one database, comprising: accessing: model data, representing a model defining the structure of the data, metamodel data, representing a metamodel defining the structure of the model, and rule data, representing at least one rule for accessing the data, said at least one rule specifying at least one constraint in terms of a property of the metamodel; processing the rule data, and accessing the data in said at least one database in dependence on the processed rule data. Related systems, methods and computer systems are also disclosed.

The present invention relates to a system and method for accessing data stored in at least one database.

Databases allow the storage of data in accordance with a defined structure, known as the model of the data. The data comprises a sequence of numerical or other values, and the model defines entities, attributes and relationships of the data. Conventionally, databases are created by defining a suitable model for the data, implementing the model in a database (by defining database tables, rows and relationships, for example), writing database interface code to allow application programs and the like to access data in the databases, and then populating the database with data.

Sometimes it is necessary to validate data to be written to the database. For example, to ensure data integrity it may be desired to prohibit the creation of a ‘customer’ record in a database if a NULL customer name is provided. Accordingly, the database interface code for writing customer records may include code which tests the length of a ‘name’ string and causes the write operation to be aborted with an error if the length is zero. Using such code, essentially arbitrarily complicated and customised validations may be performed. The validation is sometimes carried out by application programs which use the database interface, instead of by the database interface, particularly in the case of legacy applications.

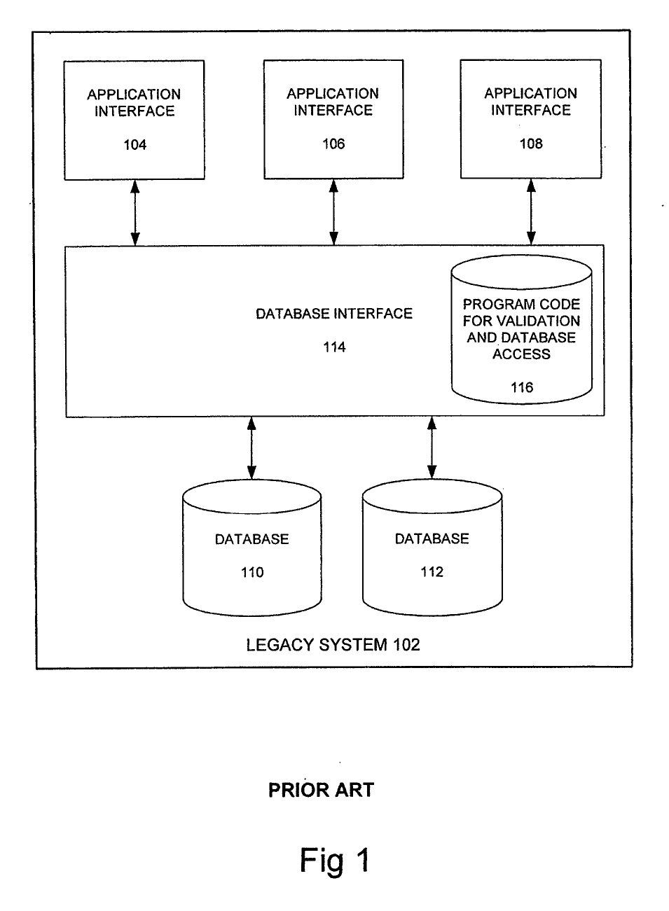

By way of example, FIG. 1 illustrates a typical legacy database system which might be employed by a telecommunications provider to track their customers, assets, and so on, for example. The system 102 contains application interfaces 104, 106, 108, a plurality of databases 110, 112, a database interface 114, and a memory store 116 containing program code for controlling access to the databases. In the context of a telecommunications management system, the databases may contain customer data and asset data, respectively, for example, and the applications associated with the application interfaces may deal with customer relations management, service fulfillment and invoicing functions, for example.

Application programming interfaces (APIs) provided by the program code 116 provide access to the databases, and also carry out validation functions. The results of database operations are then passed back to the relevant application interface by the database interface. In the context of a telecommunications management system, the database interface may be an EAI (Enterprise Application Integration) bus, for example. Dedicated access and validation code is provided in the program code 116 for each set of applications, allowing each component of the system (such as customer relations management, service provisioning and billing) to be operated essentially independently of any other.

However, the structure of this type of system can causes problems. Whenever the format of data in the databases is changed, for example to amend, add or delete a table in the database, consequential changes are required to the program code for validation and database access. Updating the validation code typically involves a long cycle of rewriting, testing and deployment of the new program code. Furthermore, it is possible for inconsistencies to arise in the access code provided for different application interfaces, whereby different validation is performed for different invoking applications. Such inconsistencies may result in a customer order being accepted by one branch of an organisation but being refused by another, for example.

Increased centralisation of the access and validation code can address the problem of inconsistent interfaces, but can increase the code complexity and result in even longer development cycles, potentially outweighing the benefits.

An object of the present invention is to provide an improved system and method for accessing data stored in one or more databases.

One aspect of the present invention provides a system for accessing data, comprising: at least one database containing the data; storage means for storing: model data, representing a model defining the structure of the data, metamodel data, representing a metamodel defining the structure of the model, and rule data, representing at least one rule for accessing the data, said at least one rule specifying at least one constraint in terms of a property of the metamodel; and processing means adapted to process the rule data and to access the data in said at least one database in dependence on the processed rule data. The use of metamodel data facilitates the use of information-based rules in place of hard-coded validation and access routines. Accordingly, validation can be more consistently performed. In addition, database data structures and validation rules can be altered without requiring the rewriting of any code, thus increasing development time and system stability.

The processing element of the system can be provided essentially independently. Accordingly, another aspect of the present invention provides a system for accessing data stored in at least one database, comprising: access means for accessing: model data representing a model defining the structure of the data, metamodel data, representing a metamodel defining the structure of the model, and rule data, representing at least one rule for accessing the data, said at least one rule specifying at least one constraint in terms of a property of the metamodel; and processing means for processing the rule data to apply said at least one rule to the data in said at least one database.

The system may further comprise receiving means for receiving selection data identifying a rule represented by the rule data, and wherein the processing means is adapted to apply the selected rule. This can allow rules to be applied essentially on demand by applications and other entities in communication with the system.

The access means may be further adapted to access the data in said at least one database, and the processing means may be adapted to process the data in accordance with said at least one rule, which can allow the system to apply rules to the databases without the involvement of external systems such as database manager systems, and can thus allow the system to be provided as a stand-alone unit.

The processing means may be adapted to select data from at least one of said at least one database, and to process the selected data in accordance with the rule data to determine whether the selected data complies with said at least one rule. The system may furthermore comprise means for updating the selected data so that the selected data complies with said at least one rule. This can facilitate ‘post-change validation’, for example to provide the rule-based validation in systems when legacy applications (which cannot easily or reliably be modified) interact directly with the databases. This feature may also be provided or adapted in order to extrapolate or interpolate data requested from the system, for example to use one or more rules, when the validation has failed, to determine or to specify what changes should be made (for example adding, amending or deleting data). This latter feature may also be provided independently of the validation function.

The processing means may be further adapted to generate a database query corresponding to at least one selected rule, and the system may further comprise output means for outputting the database query. This can allow the system to be more easily interfaced with the other systems; since the database query can be transformed or otherwise processed if necessary by external systems.

The access means may be further adapted to access rule class data representing at least one rule class, each rule class including at least one parameter (such as ‘EntityName’, ‘AttributeName’, ‘EntityRoleName’, and so on) corresponding to a property of the metamodel, and the rule data may include for said at least one rule an association between the rule and a corresponding rule class, and values for the relevant rule class parameters. The processing means may be adapted to process said at least one rule in a manner dependent on the rule class associated with the rule (such as processing data to locate matching attributes, or to locate related objects, or to carry out a comparison of data using a specified comparison operator, and so on). Each rule class may have an output type associated with it (such as database object, Boolean, and so on), and the processing means may be adapted to produce an output for said at least one rule in accordance with the output type specified by the relevant rule class. The use of rule classes can simplify the operation of the system whilst retaining considerable flexibility. Additional rule classes can be provided as and when necessary, although a relatively small set of classes were found to account for the vast majority of operations typically required to be carried out in a data processing system.

Each rule may comprise at least one validation rule, and the processing means may be adapted to generate an output (such as a Boolean value) in dependence on whether a constraint specified by said at least one validation rule is complied with. Said at least one validation rule may specify a first rule input, a second rule input, and a comparison operator, and the processing means may be adapted to perform a comparison between the first rule input and the second rule input in accordance with the comparison operator. Other forms of validation, such as outputting a predetermined value if a database object conforming to specified criteria exists, are also possible.

Each rule may comprise at least one query rule, and the processing means may be adapted to select at least one database object (such as one or more database elements, columns, rows, tables, and so on) matching the constraint specified by said at least one query rule.

Furthermore, the processing means may be adapted to apply at least one further rule included in said at least one selected database object. This can increase the flexibility of the system, since it allows the determination of which rules to apply to be carried out at ‘run-time’, rather than at ‘design-time’. As a consequence, new rules and logic can be introduced and executed at the appropriate time without requiring existing rules to be modified.

Each rule may comprise at least one rule including a reference to a plurality of further rules (optionally by specifying database objects corresponding to the further rules, as mentioned above), and the processing means may be adapted to apply the further rules. The processing means may be further adapted to apply the further rules in an ordered sequence defined by said at least one above-mentioned rule, and to link preceding further rules and successive further rules in accordance with rule linkage specifiers defined by said at least one above-mentioned rule. In particular, the processing means may be adapted to link preceding further rules and successive rules by performing at least one of the functions of: linking the output of a preceding rule to the input of a successive rule (‘pipelining’ the rules), intersecting the output of a preceding rule and a successive rule, and forming the union of the output of a preceding rule and a successive rule. The provision of ‘composite’ rules (either ‘static’, including static references to other rules, and/or ‘dynamic’, locating further rules using a database query, as mentioned above) can increase the functionality of the system whilst retaining a simple interface. For example, very complicated queries and/or validation may be performed in response to invoking a single ‘composite’ rule.

The system may further comprise means for receiving at least one parameter (such as an object name or identifier), and the processing means may be adapted to process said at least one rule using said at least one parameter as an input. This can allow the rules to be tailored to specific circumstances, for example to apply rules to a specified database object or other entity.

The rule data may include group data specifying a group membership for at least one rule, and the processing means may be adapted to process the group data to apply rules belonging to a specified group. The provision of rule groups can make it easier to organise large numbers of rules, and also to facilitate the operation of ‘composite’ rules which reference other rules (and particularly the dynamic rules mentioned above).

The system may further comprise input means for inputting a selection of a rule class, and for inputting data to populate the rule class; and processing means for creating new rule data in accordance with the inputted class selection and inputted data. This can simplify the creation of new rules. This feature may be provided in independent form.

The system may further comprise means for outputting version data associated with the new rule data, and the processing means may be adapted to process the version data to select rules corresponding to a specified version. This can assist debugging and testing of new rules, and can allow the rule set to be reverted to an earlier version if problems arise with the latest rule set.

When the data is stored in a plurality of databases, the model may define a data structure covering all of the databases, for example to define a ‘common model’ of data. The system may include means to transform the model to and from a series of underlying ‘physical’ data models associated with particular databases, and to carry out type conversions and name conversions as appropriate, for example.

The system may further comprise access means for accessing cross-reference data representing cross-references between different portions of the data. The system may further comprise processing means for processing the data to identify links between one portion of the data and another portion of the data, and generating cross-reference data representing the links (the processing means may include data cleansing tools applying heuristics to identify links between data objects, for example). Furthermore, the system may further comprise processing means for processing a request to access the data, adapted to retrieve the requested data and cross-reference data corresponding to the requested data; and output means for outputting the requested data and the cross-reference data corresponding to the requested data. The use of cross-referencing data can allow ambiguities in the data to be resolved, and to allow the system to generate uniquely-identifiable data, with the benefit that processes invoking the system can track data across multiple calls to the system, for example. This aspect may be provided in independent form.

The output means may be adapted to combine the requested data and the cross-reference data into a single data set, for example so that the cross-reference data appears to form part of the data requested from the databases. This can allow cross-reference data to be provided to applications without requiring any processing of the cross-reference data on the part of the invoking applications.

The process of generating catalogues of products and services offered by an organisation has previously been difficult because of the diversity of technical and financial information which needs to be collected from different and largely autonomous domains of the organisation. Data may be duplicated between databases in customer relations management (CRM) divisions, billing divisions and service fulfillment divisions, and differences in database formats and models can make it difficult to the necessary extract data.

In an aspect of the present invention, the processing means may be adapted to process the rule data to select database objects corresponding to a set of products or services, and to process the selected database objects to generate a list of the products or services.

The system may further comprise output means for outputting catalogue data representing a catalogue of products or services, the output means being adapted to include the list of products or services in the catalogue data. Thus, the system can provide a flexible and easily repeatable process for creating catalogues based on data stored in a plurality of possibly diverse and mutually-incompatible databases. This aspect may be provided independently.

The processing means may be adapted to select product or service description data from a first database and to select product or service price data from a second database. This can allow diverse product and price data sources to be combined in a repeatable, defined fashion to create catalogues of products essentially on demand.

The access means may be further adapted to access at least one further database for holding data migrated from the plurality of databases, and wherein the system further comprises: receiving means for receiving a request to access data; and routing means for processing the received request to determine whether the data has been migrated to said at least one further database, and for routing the request accordingly. This can allow data to be migrated from one database to another whilst keeping available access to the data (previously data migrations from one or more databases to another have taken place by taking all relevant databases off-line for the duration of the migration). This feature may also be provided independently.

Accordingly, in another aspect of the invention there is provided a system for facilitating the migration of data from at least one first database to at least one further database, comprising: access means for accessing: data in said at least one first database; data in said at least one further database; and receiving means for receiving a request to access data; and routing means for processing the received request to determine whether the data has been migrated to said at least one further database, and for routing the request accordingly. The system may further comprise means for accessing migration data, containing a record of data which has been migrated (or similar), or alternatively the identification of data which has been migrated may be carried out by the application of a rule as described above.

The system may further comprise transfer means (such as a data processing unit in communication with both databases) for transferring data from said at least one first database to said at least one further database (and, if appropriate, updating the migration data accordingly). The routing means may be adapted to process rule data to determine the database to which the request should be routed (for example, with the rule identifying database objects which have been migrated). This can provide a flexible and efficient way to track the migration of data from one database to another.

In a further aspect of the invention there is provided a database system for use with the system as aforesaid, comprising: at least one database containing the data; and storage means for storing: model data, representing a model defining the structure of the data; metamodel data, representing a metamodel defining the structure of the model; and rule data, representing at least one rule for accessing the data, said at least one rule specifying at least one constraint in terms of a property of the metamodel.

The database system may further comprise: communication means for passing a request to a system as aforesaid for accessing data stored in a plurality of databases, and for receiving an output from the system, the request including a specifier identifying at least one rule corresponding to the operation to be performed, and the output representing the result of applying said at least one rule; and processing means for selectively performing the operation in dependence on the received output. The database system may alternatively include receiving means for receiving a request to carry out a given functionality (in the form of a ‘universal adaptor’ for interacting with the system as aforesaid, for example), the alternative receiving means being adapted to translate the received request into a request to execute a rule; the rule to be executed may be specified by an external system (such as the system as aforesaid), such that the interaction between the database system and the system as aforesaid may be reconfigured without requiring a change to other aspects of the database system. Other systems, devices and methods incorporating the system as aforesaid for accessing a plurality of databases may of course be envisaged.

In another aspect of the invention, there is provided a method of accessing data stored in at least one database, comprising: accessing model data, representing a model defining the structure of the data; metamodel data, representing a metamodel defining the structure of the model; and rule data, representing at least one rule for accessing the data, said at least one rule specifying at least one constraint in terms of a property of the metamodel; and processing the rule data, and accessing the data in said at least one database in dependence on the processed rule data. Related methods are also provided.

In another aspect of the invention there is provided a method of providing a product or service, comprising: providing a model of data representing aspects of the product or service, providing a metamodel defining the structure of the model; and providing at least one rule for accessing the data, providing at least one rule for accessing the data, said at least one rule imposing a constraint defining characteristics of the product or service.

In a further aspect of the invention there is provided a computer system for accessing data stored in a plurality of databases, comprising: an instruction memory storing processor implementable instructions; and a processor operable to read and process the data in accordance with instructions stored in the instruction memory; wherein the instructions stored in the instruction memory comprise instructions for controlling the processor to perform a method as aforesaid (or a method embodied in a system as aforesaid), and in particular to perform a method comprising: accessing: model data, representing a model defining the structure of the data, metamodel data, representing a metamodel defining the structure of the model, and rule data, representing at least one rule for accessing the data, said at least one rule specifying at least one constraint in terms of a property of the metamodel; and processing the rule data to apply said at least one rule to the data in said at least one database.

The present invention can be implemented in any convenient form, for example using dedicated hardware, or a mixture of dedicated hardware and software. The present invention is particularly suited to implementation as computer software implemented by a workstation or laptop computer. The invention may further comprise a network, which can include any local area network or even wide area, conventional terrestrial or wireless communications network. The systems may comprise any suitably programmable apparatuses such as a general purpose computer, personal digital assistant, mobile telephone (such as a WAP or 3G-compliant phone) and so on. Aspects of the present invention encompass computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Although each aspect and various features of the present invention have been defined hereinabove independently, it will be appreciated that, where appropriate, each aspect can be used in any combination with any other aspect(s) or features of the invention.

Embodiments of the present invention will now be described with reference to the accompanying drawings, in which:

FIG. 1 is a schematic diagram of a prior art database access system;

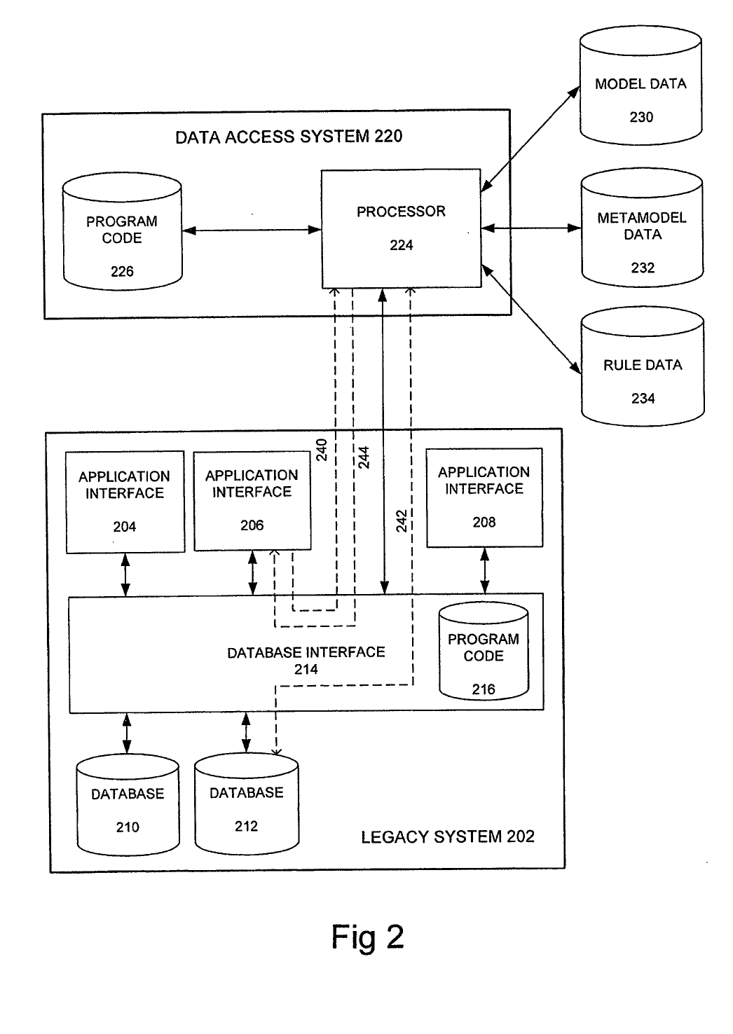

FIG. 2 is a schematic diagram of a database access system in accordance with an embodiment of the present invention;

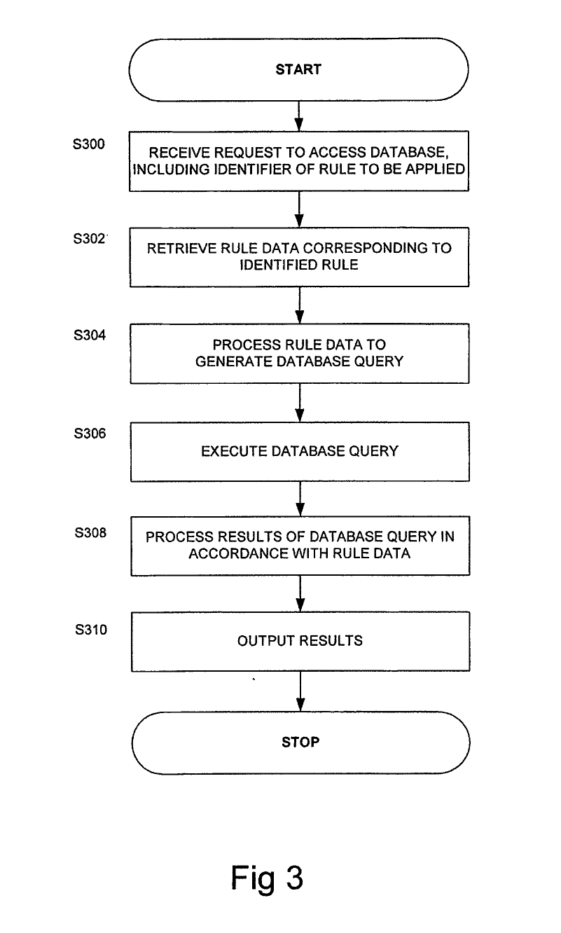

FIG. 3 is a flow chart illustrating the operation of the data access system shown in FIG. 2;

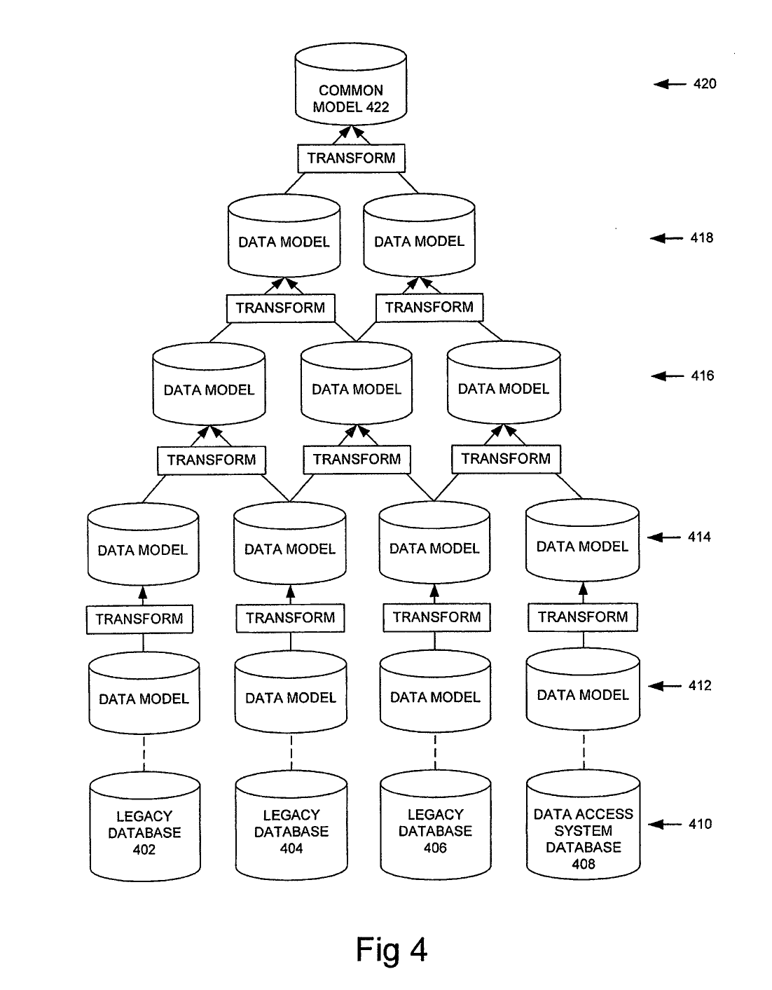

FIG. 4 is a schematic illustrating the formation of a common model for use in the system of FIG. 2;

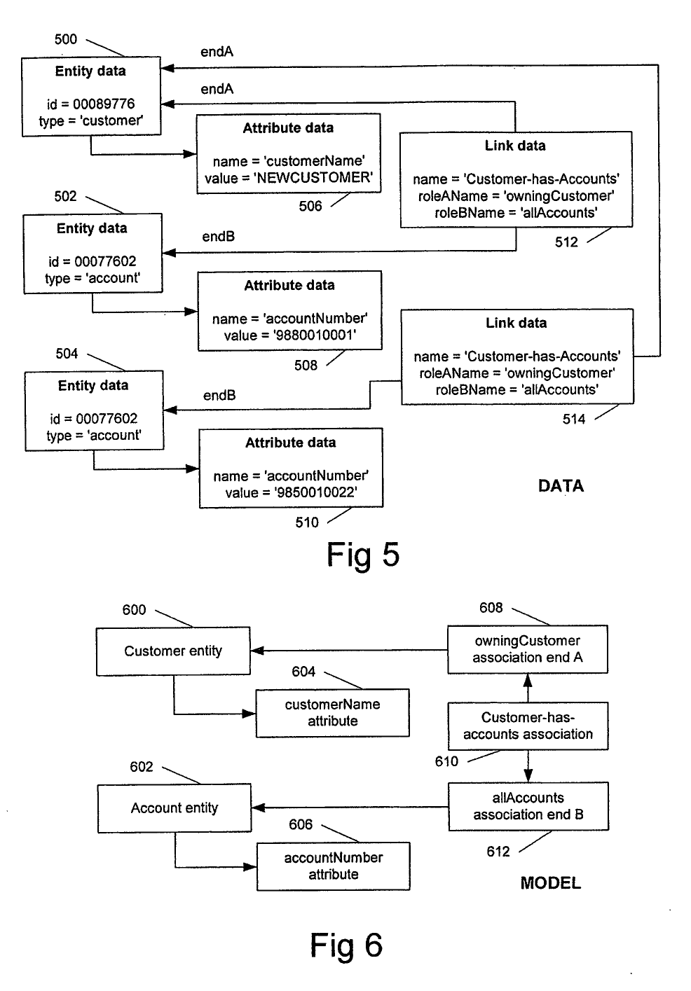

FIG. 5 is a schematic illustrating a typical set of data for use in the system of FIG. 2;

FIG. 6 is a schematic illustrating a set of model data representing the structure of the data in FIG. 5;

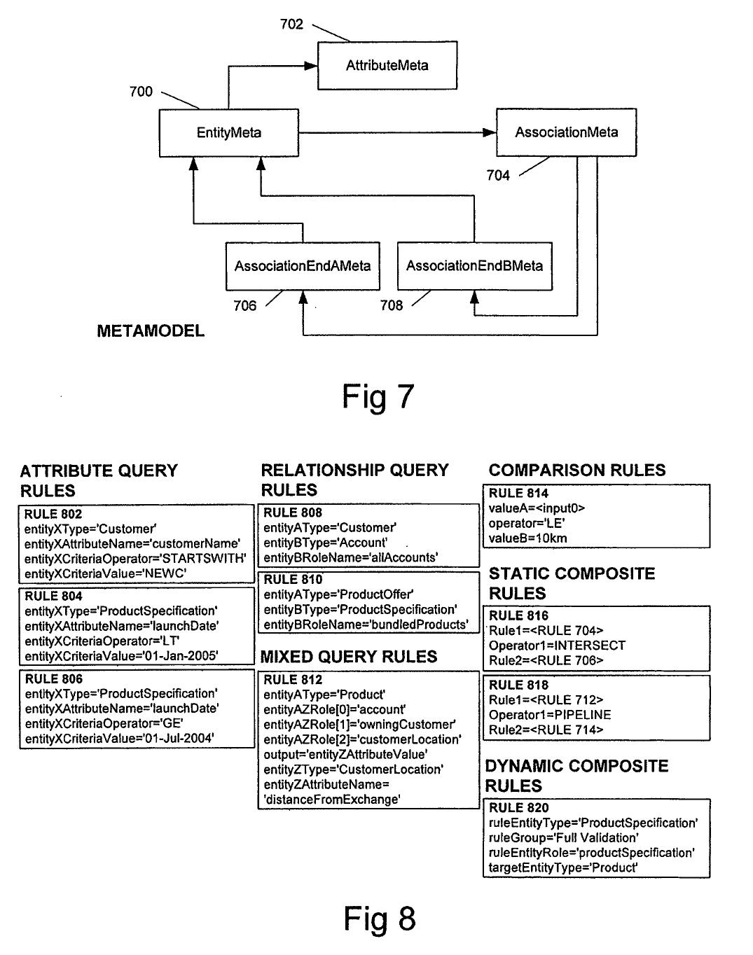

FIG. 7 is a schematic illustrating a set of metamodel data representing the structure of the model data in FIG. 6;

FIG. 8 is a list showing examples of rules which might typically be processed by the data access system of FIG. 2;

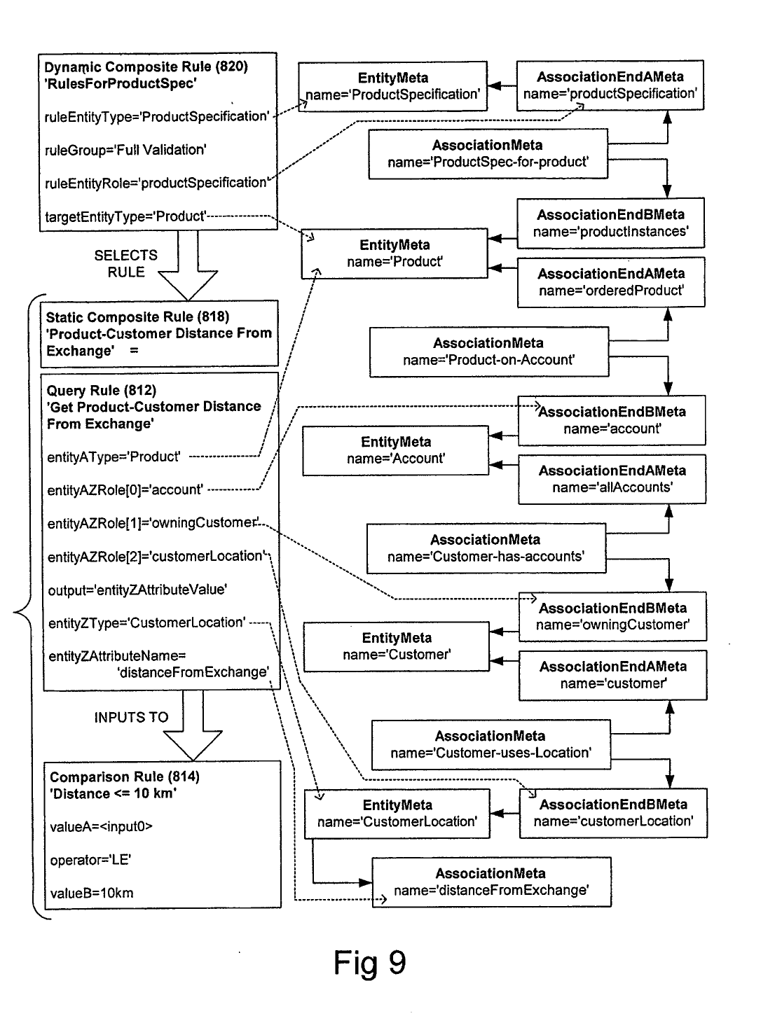

FIG. 9 illustrates the operation of various of the rules shown in FIG. 8;

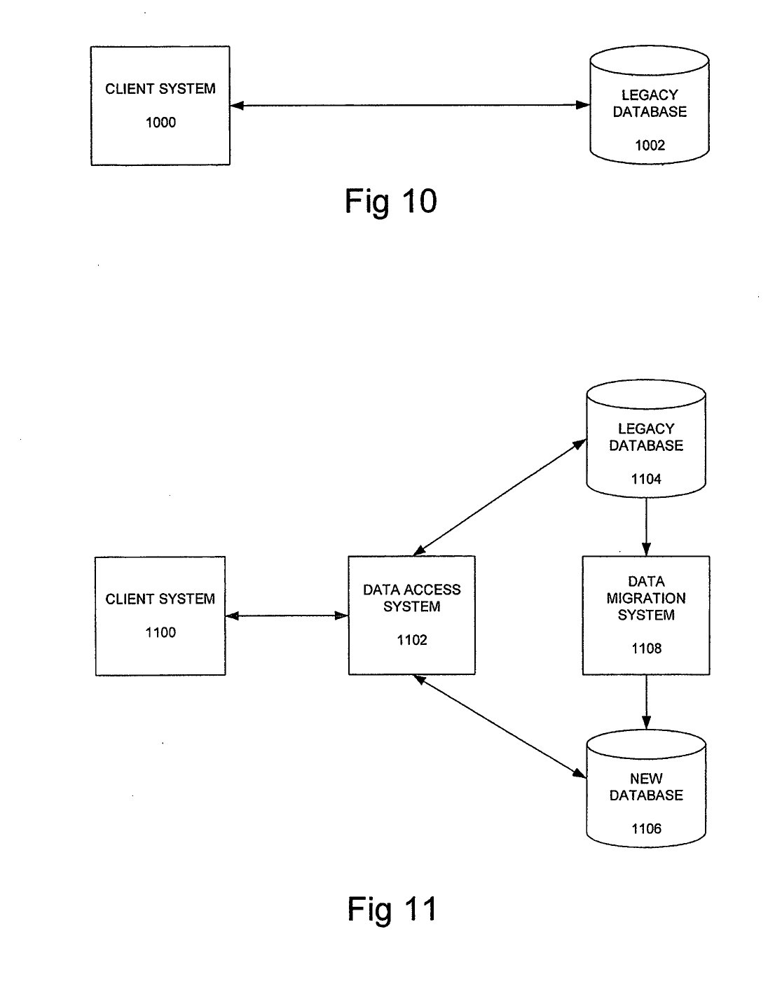

FIG. 10 is a schematic of a legacy data access system;

FIG. 11 is a schematic of the system of FIG. 10 during migration of data to a new database;

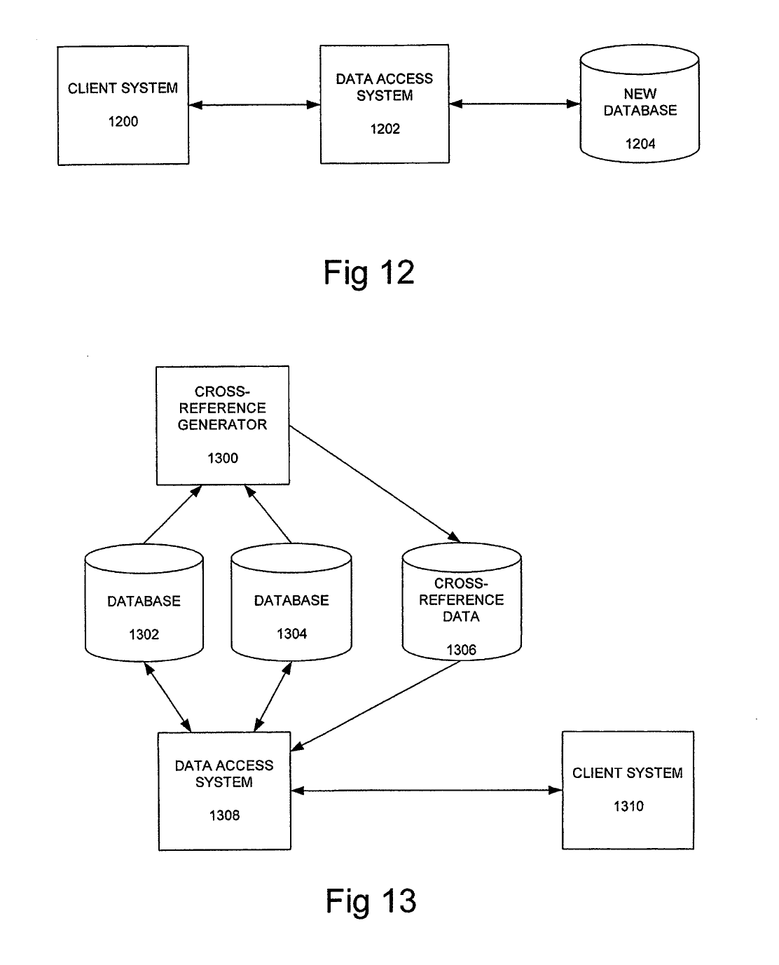

FIG. 12 is a schematic of the system of FIGS. 10 and 11 after the data migration has been completed;

FIG. 13 is a schematic of a system for cross-referencing data in the system of FIG. 2;

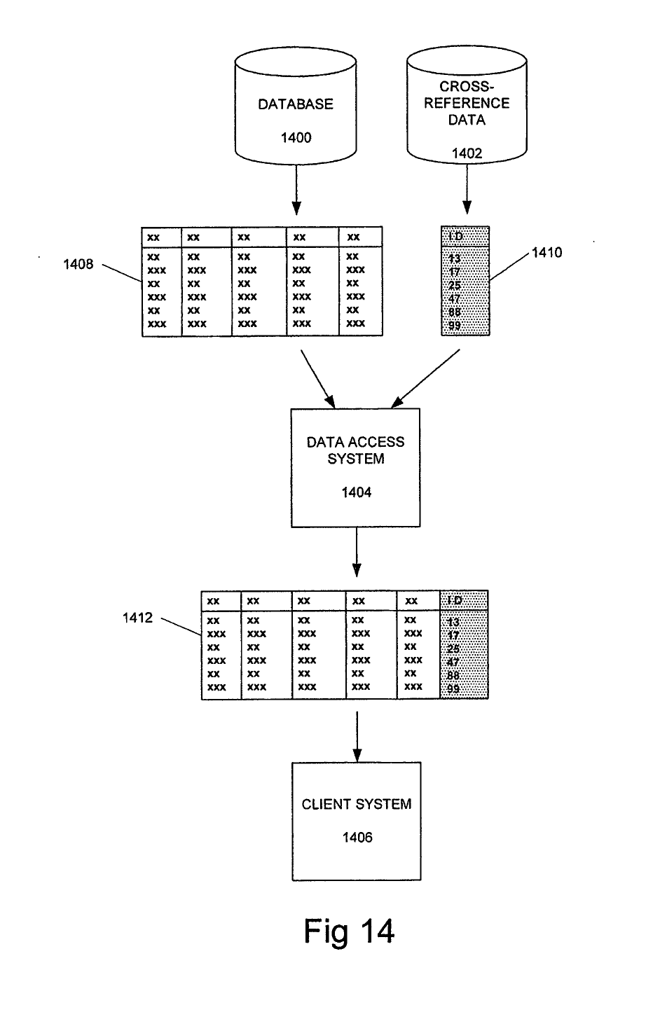

FIG. 14 is an illustration of the use of cross-referencing in the system of FIG. 13;

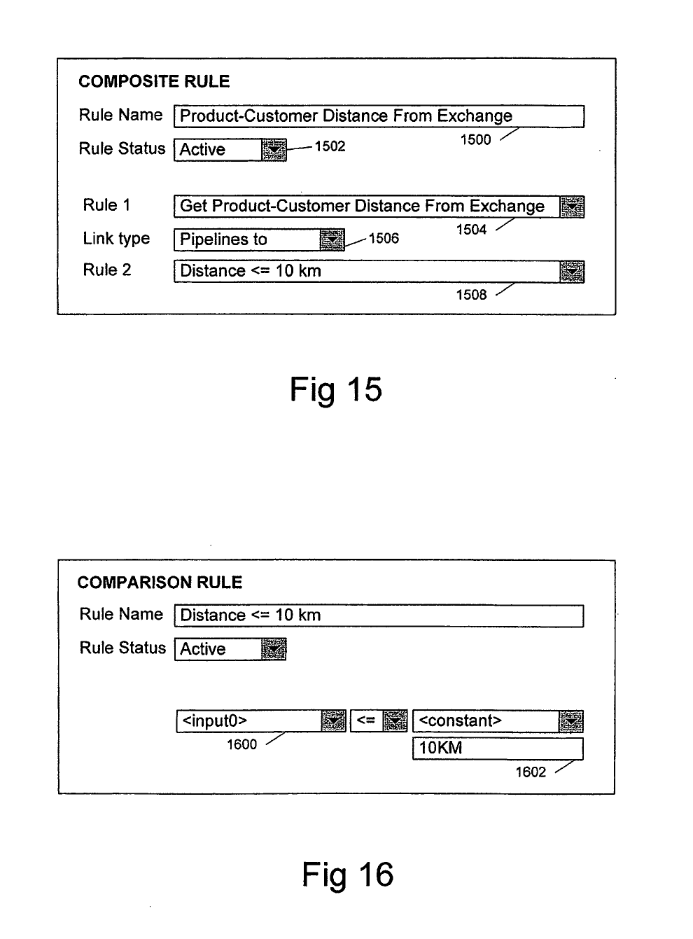

FIG. 15 is an illustration of a user interface for use with the system of FIG. 2;

FIG. 16 is an illustration of another user interface for use with the system of FIG. 2;

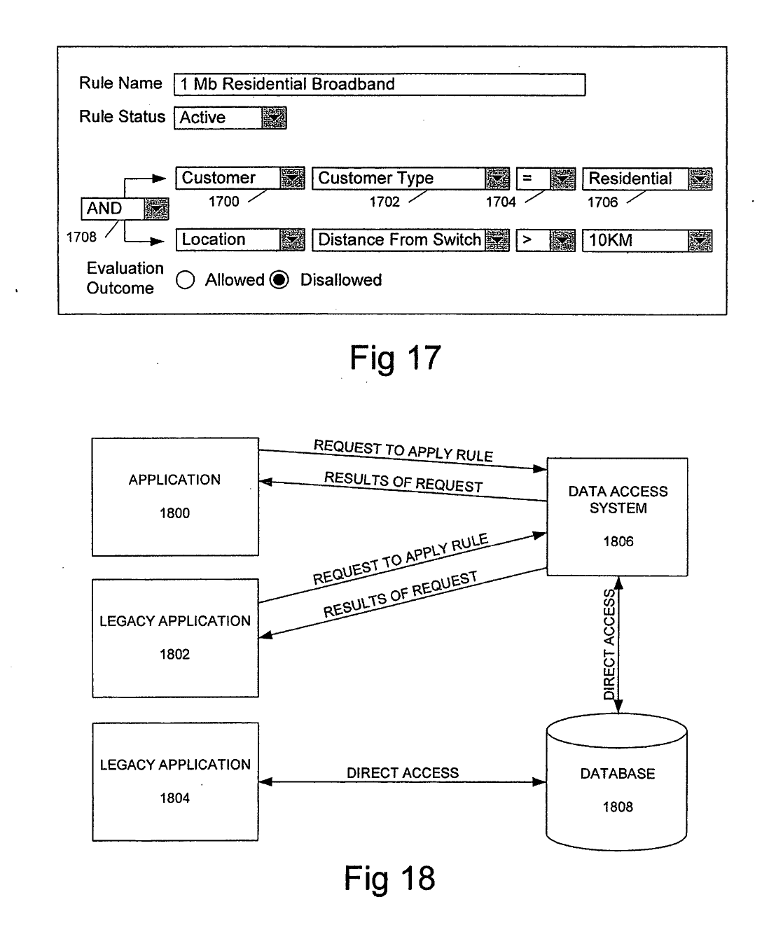

FIG. 17 is an illustration of a further user interface for use with the system of FIG. 2;

FIG. 18 is a schematic illustrating the interaction between the data access system of FIG. 2 and a plurality of applications;

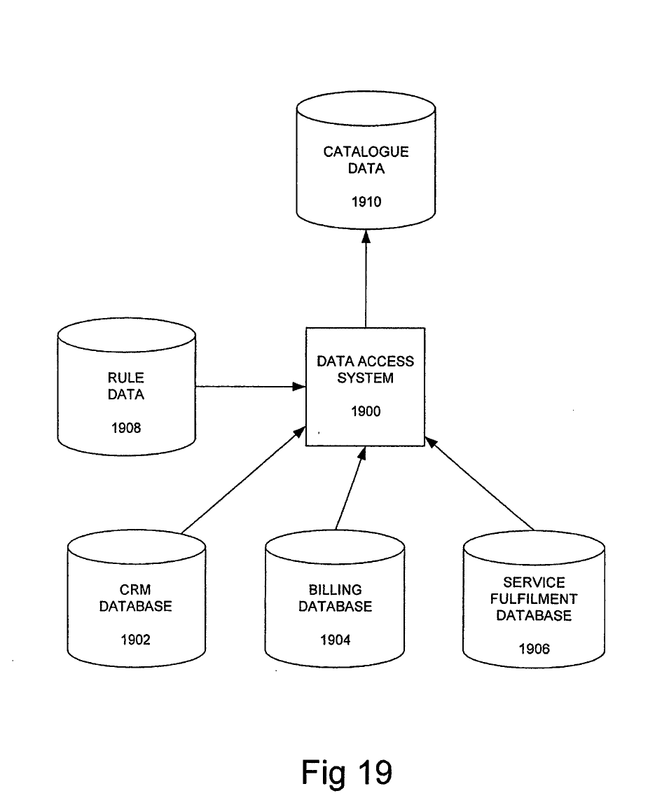

FIG. 19 is a schematic of a catalogue generating system based on the system of FIG. 2;

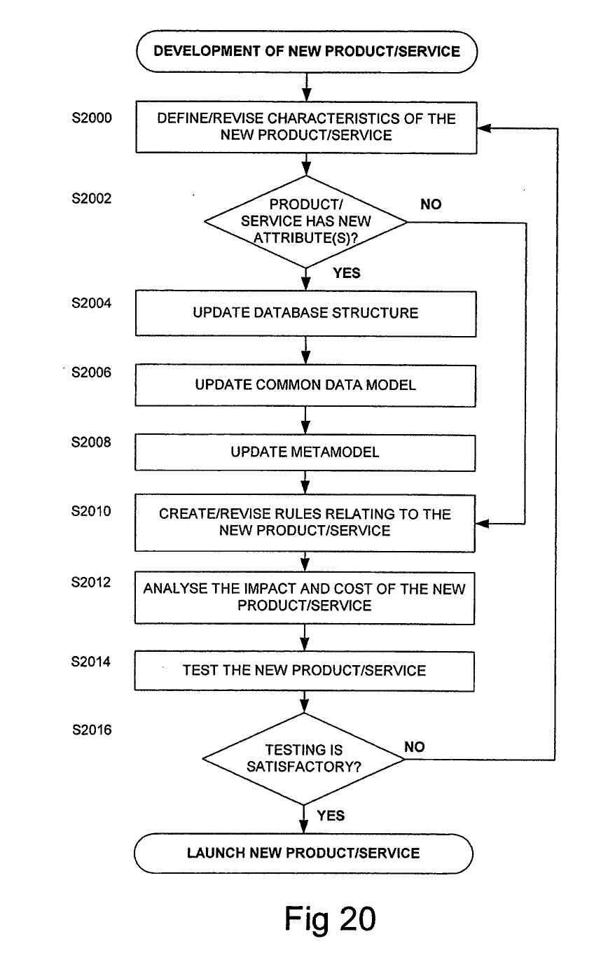

FIG. 20 is a flowchart illustrating a process for creating a new product or service for use with the system of FIG. 2; and

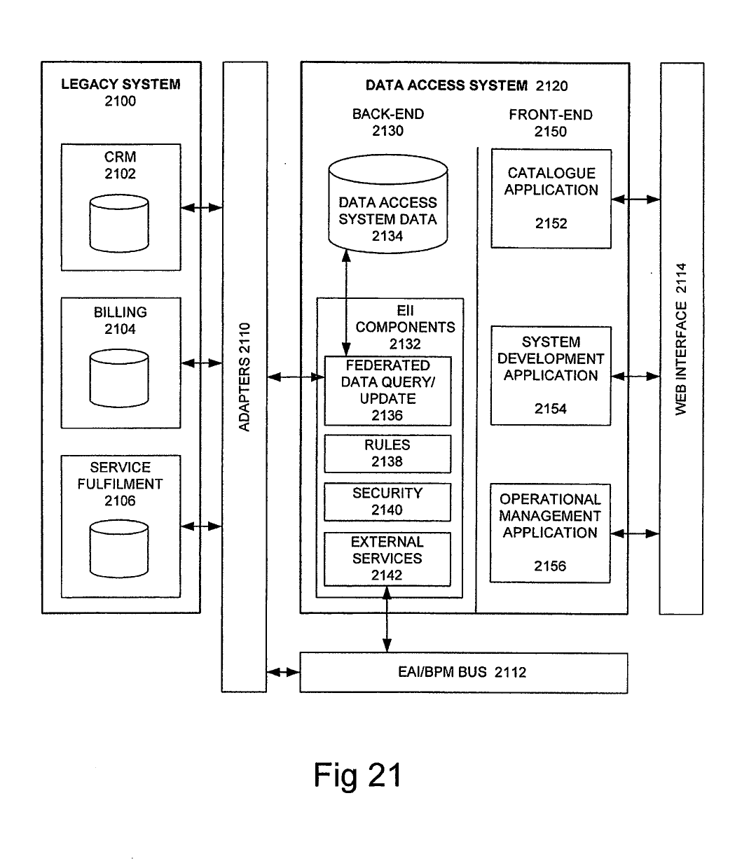

FIG. 21 is a schematic showing an example of the system of FIG. 2 in more detail.

FIG. 2 is a schematic diagram of a database system in accordance with an embodiment of the invention. The system includes a legacy system 202 and data access system 220. The legacy system 202 contains application interfaces 204, 206, 208, a plurality of databases 210, 212, a database interface 214, and a memory store 216 containing program code for controlling access to the databases.

The data access system 220 contains a processor 224 and program code store 226 containing program code for execution on the processor 224. The data access system 220 provides access to a data store containing model data 230, a data store containing metamodel data 232, and a data store containing rule data 234.

During operation of the system, an application may generate a request to access data in one of the databases 210, 212 (for example to read or to write particular a set of data). The request 240 is passed to the database interface 214 via the application interface 206 (say) and then routed to the processor 224 in the data access system 220. The processor 224, under control of the code 226, then processes the request using the model data 230, metamodel data 232 and rule data 234 to form a database query corresponding to the request. The processor 224 then communicates 242 with the appropriate database 212 via the database interface 214 to execute the database query, and returns the appropriate results 240 to the application via the application interface 206. The operation of the data access system 220 is described in more detail below.

FIG. 3 is a flow chart illustrating the operation of the data access system shown in FIG. 2.

The data access system first receives a request (step S300) to access the database from an application or other component of the legacy system. The request includes a rule identifier, specifying a rule which is to be applied by the data access system. The data access system retrieves rule data (step S302) corresponding to the identified rule, and processes the rule data (step S304) using the model data and metamodel data (see below) to generate a database query embodying the rule logic. The data access system then executes the database query (step S306), and receives the results of the query. The results are processed (step S308) in accordance with the type of rule which is being applied (see below), and an output is generated (step S310) representing the result of applying the rule. As is explained in more detail below, the result may be one or more database objects matching the database query, or a Boolean value indicating whether a validation has succeeded or failed, for example.

The model data 230 will now be described in more detail.

FIG. 4 is a schematic illustrating the formation of a common model (the model data 230) for use in the system of FIG. 2. A number of databases (including legacy databases 402, 404, 406 and a database 408 used by the data access system) form a physical data layer 410. The databases 402, 404, 406 include the databases 210, 212 of FIG. 2.

The data in each database 402, 404, 406, 408 is organised in accordance with a data model associated with each respective database, forming a data model layer 412. The data models comprise entities (such as tables of data), attributes (such as the columns in the tables) and associations (data linking different entities in the databases). The model layer 412 is ‘physical’ in the sense that each attribute or association describes the actual structure of the data in the relevant database.

The data models in the model layer 412 are transformed into a further model layer 414 having the same structure as the underlying layer 412 but with standardised data types, allowing the data models of each database to be more easily manipulated. Further transformations are then carried out to combine tables and other elements of the data models in the data model layer 414 so as to form a simpler, more compact set of data models in the data model layer 416. The process is repeated for data model layers 416, 418 until a single (common) model 422 is formed at the highest level 420 of the data model layers.

The transformation is performed primarily by defining higher level models in terms of SQL queries operating on lower level models. The MetaMatrix (RTM) program was found to be a convenient choice for carrying out the transformations, and allows the incorporation of databases providing only an application programming interface (API) for accessing data, as well as databases with more flexible SQL interfaces. The transformations can allow modification of data in the databases (via ‘insert’, ‘update’ and ‘delete’ queries) as well as providing read-only interfaces (via ‘select’ queries). The structure of the common model 422 is typically designed by a systems architect and/or users of the system, having regard to the operations which will be required to be performed on the data in the databases.

The relationship between data, model data and metamodel data will now be described in more detail with reference to FIGS. 5 to 7.

FIG. 5 is a schematic illustrating a typical set of data for use in the system of FIG. 2.

The data includes one entity 500 representing a customer, and two entities 502, 504 representing accounts. In a table-based relational database, the entities may represent rows in a customer table and an account table respectively, for example. The data also includes attributes 506, 508, 510 associated with the entities 500, 502, 504. The attribute 506 may represent the value ‘NEWCUSTOMER’ in a ‘customerName’ column of a ‘customer’ table, for example, and the attributes 508, 510 may represent the values ‘9880010001’ and ‘9850010022’ in two different rows in the ‘accountNumber’ column in a an ‘account’ table. Lastly, the link data 512, 514 represent associations between the customer entity 500 and the two account entities 502, 504. The link data may be two rows in a ‘Customer-has-Accounts’ table, for example, containing foreign keys linking to primary keys of records in the ‘customer’ and ‘account’ tables. The data may, of course, have a different internal representation within different types of databases, such as object-oriented databases or non-relational databases.

FIG. 6 is a schematic illustrating a set of model data representing the structure of the data in FIG. 5.

The model represents the structure of the data shown in FIG. 5. A customer entity 600 and an account entity 602 are defined, and group together the data entity 500 and the data entities 502, 504 respectively. The model also defines the customerName attribute 604 of the Customer entity, and the accountnumber attribute 606 of the Account entity. The Customer-has-accounts association 610 is also defined, grouping the link data 512, 514, and the link data roles 608, 612 are also defined.

The common model 422 used in the system is of a form as shown in FIG. 6. The provision of the model allows the entities, attributes and relationships of the data to be identified and processed.

FIG. 7 is a schematic illustrating a set of metamodel data representing the structure of the model data in FIG. 6.

The metamodel represents a further degree of abstraction of the data in the databases. FIG. 7 illustrates the relationship between a number of classes which embody elements of the metamodel. The metamodel includes an EntityMeta class 700 representing model entities (including customer and account entities 600, 602), an AttributeMeta class 702 representing model attributes (including customerName and accountNumber attributes 604, 606), and an AssociationMeta class 704 representing model associations (including the Customer-has-accounts association 610). The metamodel also includes an AssociationEndAMeta class 706 and an AssociationEndBMeta class 708, providing further information defining the structure of the database model of FIG. 6. An abstract AssociationEndMeta class (not shown), from which class the AssociationEndAMeta and AssociationEndBMeta class are derived, is also provided. It will be appreciated that the metamodel may alternatively be represented by database tables or other arrangements of data having a structure similar to or identical to that shown in FIG. 7.

Using the metamodel data, the data access system is able to process an essentially arbitrary range of rules defining constraints on database data and model data without requiring model-specific computer code to be written.

FIG. 8 is a list showing examples of rules which might typically be processed by the data access system.

Rules are divided into different classes, each rule class defining a set of metamodel fields which the rules in the class provided specific values for. The different classes include attribute query rules, relationship query rules, mixed query rules, comparison rules, static composite rules and dynamic composite rules, as is described in more detail below.

The attribute query rule class finds objects of a certain type which conform to a specific attribute value criterion, and has the parameters ‘entityXType’, ‘entityXAttributeName’, ‘entityXCriteriaOperator’ and ‘entityXCriteriaValue’.

For example, Rule 802 returns ‘customer’ entities/database objects having the attribute ‘customerName’ starting with the string ‘NEWC’; Rule 804 returns all ‘ProductSpecification’ entities having a ‘launchDate’ attribute earlier than 1 Jan. 2005; and Rule 806 returns all ‘ProductSpecification’ entities having a ‘launchDate’ attribute later than 1 Jul. 2004.

When Rule 802 is processed by the data access system, it is converted into a database query of the form “SELECT * FROM Customer WHERE Customer.customerName LIKE ‘NEWC%’”, and the query is then executed. The result returned by the query is a set of database objects matching the constraints laid down by the rule, and the database objects are then passed back to the application which invoked the rule. The query and results are translated as appropriate between the ‘virtual’ common model and the data models associated with the physical databases.

The relationship query rule class finds objects of one type (B) which are linked to objects of a second type (A), and has the parameters ‘entityAType’, ‘entityBType’ and ‘entityBRoleName’.

For example, Rule 808 returns ‘Account’ entities/database objects which are linked to ‘Customer’ entities/database objects in the role of ‘allAccounts’; and Rule 810 returns ‘productSpecification’ entities which are linked to ‘productOffer’ entities in the role of ‘bundledProducts’.

When Rule 808 is processed by the data access system, it is converted into a database query of the form “SELECT Account.* FROM Account, Customer-has-accounts WHERE Customer-has-accounts.allAccounts=Account.ID”. In this case, the database query is formulated using the metamodel and/or model data to determine which association (in this case, ‘Customer-has-accounts’) links the ‘Customer’ entity to the ‘Account’ entity using the role of ‘allAccounts’.

More complicated rule classes may be provided, such as the mixed query class to which Rule 812 belongs.

As is described in more detail below with reference in FIG. 9, Rule 812 locates database objects of type ‘CustomerLocation’ which are linked to ‘Product’ entities via a cascade of relationships specified in the entityAZRole parameters. The rule produces an output equal to the ‘distanceFromExchange’ attribute(s) of the ‘CustomerLocation’ type entity(ies) specified by the database query.

Another class of rules is comparison rules, such as Rule 814. The rule is an example of a rule which does not access data in the database, but instead operates on data which has been output by other rules. The rule outputs a Boolean value of true if the value input into the rule is less than or equal to (‘LE’) 10 km, and false otherwise.

Various composite rule classes allow rules to be combined in essentially arbitrary fashions, increasing the flexibility of the system.

Rules 816 and 818 are examples of static composite rules, which combine specified other roles in specified ways. Rule 816, for example, takes the output of rule 804 (finding all ProductSpecification entities with a launch date before 1 Jan. 2005) and intersects it with the output of Rule 806 (finding all ProductSpecification entities with a launch date after 1 Jul. 2004). The result of the composite rule is a set of ProductSpecification entities relating to product specifications launched between 1 Jul. 2004 and 1 Jan. 2005.

Rule 818 is an example of a pipelining query, which takes the output of a first rule and supplies it as the input to a second rule. In this case, the rule produces a Boolean value of true if the distanceFromExchange attribute of the CustomerLocation associated with a given product is less than or equal to 10 km, and false otherwise.

Rules can be also associated with specific database objects. Accordingly, Rule 818 can be associated with a ‘2 Mb broadband’ object in the productSpecification object/table, for example. The association can then be exploited by dynamic composite rules, for example (see below).

Static composite rules may refer to any rules, including other composite rules, which can allow essentially arbitrarily complex combinations of rules to be created.

Rules may be assigned to groups, principally to assist organisation of rules, but also for use with certain classes of rules such as dynamic composite rules. Dynamic composite rules define a query in a similar fashion to other classes of rules, except that the objects located by the query are other rules.

Rule 820, for example, locates and executes all rules in the ‘Full Validation’ rule group which are linked to a ‘productSpecification’ object (ruleEntityRole=‘ProductSpecification’) or associated with a ‘ProductSpecification’ metaobject (ruleEntityType=‘ProductSpecification’). Rule 818 mentioned above is linked to the ‘2 Mb broadband’ productSpecification object, and would be located by Rule 820 (if it was assigned to the ‘Full Validation’ rule group).

FIG. 9 illustrates the operation of various of the rules shown in FIG. 8. In this figure the relationships between metamodel objects (‘metaobjects’) and their interaction with the rules can be seen.

The data access system and rule engine can also be used to facilitate the migration of data from a legacy database to a new database, as will be described in more detail below with reference to FIGS. 10 to 12.

FIG. 10 is a schematic of a legacy data access system. A client system 1000 is in direct communication with a legacy database 1002. All validation and database access logic is performed by the client system, for example using custom validation routines.

FIG. 11 is a schematic of the system of FIG. 10 during migration of data to a new database. The client system 1100 is connected to a data access system 1102, which is connected in turn to a legacy database 1104 and a new database 1106. A data migration system 1108 is provided to effect the migration of data from the legacy database 1104 to the new database 1106.

As before, a common model of the data in the legacy database 1104 is created, representing an ideal or desirable model of the data in the database 1104. The common model is then used for the format of the new database 1106. Before migration of data has commenced, the data access system 1102 operates essentially as described above, providing access to the legacy database 1104 using a rule engine operating on the common model. The data access system 1102 can be configured to permit access to the legacy database 1104 using previous legacy access methods, until all of the validation logic is removed from the client system 1100 and replaced with rule-based calls to the data access system 1102.

During migration, the data migration system 1108 transfers a portion of data from the legacy database 1104 to the new database 1106. This may be done by requesting the data access system 1102 to apply a rule selecting the portion of data to be transferred, and then storing the portion of data in the new database 1106. Once part of the data has been transferred, the data access system 1102 then performs a routing role. Incoming requests from the client system 1100 are processed to determine whether they relate to data in the legacy database 1104 or the new database 1106; if the former, the requests are processed as before using the mapping from the common model to the actual model used by the legacy database 1104. In the latter case, the requests are processed using the new database, but with no mapping of the model taking place (since the new database 1106 has a structure already corresponding to the common model).

FIG. 12 is a schematic of the system of FIGS. 10 and 11 after the data migration has been completed. The client system 1200, data access system 1202 and new database 1204 are provided.

Compared to the legacy system shown in FIG. 10, the system now benefits from a rule-based data access system 1202 which allows relatively easy modification of the validation logic and prevents the need for validation logic to be provided in the client system 1200, and a database 1204 having an improved data model, compared to the legacy database 1002 of FIG. 10. One benefit of the migration system described above with reference to FIGS. 11 and 12 is that the migration can be completed over an arbitrarily long period of time, with the transfer of data from the legacy database to the new database being entirely transparent to the client system. Any further migration to further database(s) can be undertaken without any changes being required to the client system.

An aspect of the data access system relating to cross-referencing data will now be described, with reference to FIGS. 13 and 14.

FIG. 13 is a schematic of a system for cross-referencing data in the system of FIG. 2. A cross reference generator 1300, databases 1302, 1304, a data store 1306 of cross-reference data, a data access system 1308 and a client system 1310 are provided.

When separate database models are combined into a common model, as described above, problems can arise due to a lack of references between data stored in the different models. A person‘s name may be stored in several databases, but because of inconsistencies in spelling, differences in database formats, and or the absence of unique primary keys, for example, the data relating to the name may not be treated in a unified and coherent way. The name might be deleted from one database whilst being retained in another, or a query may return multiple instances of the name, giving the appearance of more than one person existing with the name in question.

The cross-reference generator 1300 addresses this problem by creating cross-references between data stored in different databases and/or models. The cross-references are generated automatically using appropriate cross-referencing algorithms, although manual cross-references may be created (for example during data cleaning operations which correct inconsistencies in spellings, formats, and so on). The cross-references are then stored in a data store 1306 in a format understandable by the data access system 1308. As is described in more detail below, the data access system 1308 then used the cross-reference data 1306 to enhance the processing of data in the databases in response to requests from the client system.

FIG. 14 is an illustration of the use of cross-referencing in the system of FIG. 13. A source database 1400, data store 1402 of cross-reference data, data access system 1404 and client system 1406 are shown. A raw data table 1408, cross-reference data table 1410 and merged table 1412 are also shown.

When the data access system 1404 obtains from the database 1400 a set of data 1408 which does not contain the necessary index/cross-reference data, it loads the necessary cross-reference information 1410 from the cross-reference data store 1402, and merges the data, creating a composite data set 1412 which can be passed to the client system 1406. The creation and incorporation of the cross-reference data 1410 is essentially transparent to the client system 1406, allowing the cross-referencing of data to be provided without requiring modification of the client system 1406, for example.

A process for creating new rules for use by the data access system will now be described with reference to FIGS. 15 to 17.

A user interface is provided for the data access system to allow the input of rule data directly into the data access system. This allows appropriate validation to take place for any new rules, and allows rules to be brought immediately into effect if required. As will be explained in more detail below, a web interface is provided for the data entry.

FIG. 15 is an illustration of a user interface for use with the system of FIG. 2. The interface includes a rule name field 1500, a rule status field 1502 (selecting one of an ‘active’ or ‘inactive’ status), a first rule reference field 1504, a link type field 1506 (selecting from options ‘Pipelines to’, ‘Intersects’, ‘Union’) and a second rule reference field 1508.

The user interface allows the user to enter values for the parameters of the static composite rule class (Rule 818 described above with reference to FIG. 8). In particular, the user can select the ‘Rule1’ and ‘Rule2’ properties (specifying the two rules which are to be combined) from a drop-down list of all relevant rules, in this case selecting Rule 812 and Rule 814 described above. The ‘Operator1’ property can also be selected from a drop-down list offering the choices ‘Pipelines to’, ‘Intersects’ and ‘Union’).

When a rule is being created, the user selects a rule class (in this case ‘static composite rule’) and, if appropriate, a rule group to which the rule is to belong, and the system brings up the window as shown, to allow the values for the rule to be selected. The values which the user can select from are limited according to the type of data which is required to be entered. For example, the rule parameters Rule1 1504 and Rule2 1508 allow selection from a list of rules, whereas for other rule classes the rule parameters may be selected from entities, attributes or relationships of the model, constant values, and so on.

FIG. 16 is an illustration of another user interface for use with the system of FIG. 2. This user interface allows the creating or editing of comparison rules. A first value 1600 is compared using the specified operator (‘<=’) to the second value 1602. The values provided correspond to comparison Rule 814, mentioned above with reference to FIG. 8. As can be seen, the first value 1600 is a special value indicating that (as appropriate) the output of the previous rule or a parameter supplied by the application invoking the rule is to be used, rather than a predefined value. The second value 1602 is another special value, indicating that a constant value, rather than data from the database, is to be used.

More complicated rule classes and, correspondingly user interfaces for populating the rule classes, can be provided.

FIG. 17 is an illustration of a further user interface, for example, for use with the system of FIG. 2. The relevant rule class is an example of an evaluation rule type, which is a variant of the comparison rule type. The rule carries out two independent comparisons, each comparison including a database entity/table field 1700, an attribute/column field 1702 relating to the entity/table, a comparison operator 1704, and a comparison value field 1706, which may be selected from a list of predefined possible values, or which may be another constant value. A logical operator 1708 (in this case ‘AND’) links the two comparisons. An evaluation outcome 1710 is then carried out if the evaluation is true. In this case, an action (such as the selection of the ‘1 Mb Residential Broadband’ product) is disallowed if the criteria are met (namely, the customer is a residential customer located more than 10 km from the nearest switch).

A feature of the data access system relating to data validation for legacy applications will now be described.

FIG. 18 is a schematic illustrating the interaction between the data access system of FIG. 2 and a plurality of applications. A first application 1800, second (legacy) application 1802 and third (legacy) application 1804, a data access system 1806 as described above, and a database 1808 are shown.

The application 1800 is an application which has been designed from its initial inception to interface with the data access system 1806. The application 1800 contains no validation code, for example, but instead includes routines for invoking calls to the data access system 1806 for performing validation and other database-related tasks (such as creating, reading, updating and deleting database objects). Since all relevant database access takes place via the data access system 1806 and its system of rules, validation of data takes place before any data is written to the database.

The application 1802 is a legacy application which was designed to operate on the database 1808 directly, and which originally contained its own code for performing database tasks such as validation. The application 1802 has been re-engineered, however, to substitute calls to the data access system 1806 for direct access to the database. Any further changes to the database model, or the introduction of new products or services (requiring new validation steps to be carried out) can be undertaken without further modification to the legacy application 1802.

The other legacy application 1804 has not been, or cannot be, altered (for example because the relevant source code or developers are no longer available) to update the database handling code to communicate instead with the data access system 1806 instead of directly accessing the database 1808.

In order to allow the legacy application 1804 to continue to operate whilst at the same time allowing the database access logic (such as the validations required to be performed) to be changed, the data access system provides a ‘post-change validation’ function. Whenever the legacy application 1804 has been detected as having made a change to the database (or else on a periodic basis if such a change cannot easily be detected), the data access system 1806 applies one or more rules to data in the database to determine whether the data complies with the rules.

The selection of rules to apply depends on the nature of changes which may be made by the application 1804, and/or the nature of any new products and services which may be provided. For example, if new broadband services are provided by the operator of the system, and the legacy application 1804 was designed with only POTS (plain old telephone system) connections in mind, rules may be applied which relate to distances from the exchange, for example (being an issue mainly affecting broadband services).

If the data access system 1806 detects that data in the database 1808 does not comply with the rules, the non-compliance can be brought to the attention of an operator of the system. Alternatively, further rules may be provided to specify how the invalid data is to be treated; some examples of invalid data may automatically be ‘fixed’ using a data correction algorithm, for example.

The data validation process described above may also be applied more generally as a periodic ‘systems check’, for example, to ensure the integrity of the data in the database.

The use of the data access system to assist in the generation of catalogue data will now be described, in the context of products and services offered by a telecommunications operator.

FIG. 19 is a schematic of a catalogue generating system based on the system of FIG. 2. In the system, a data access system 1900 as described above is in communication with a customer relations management (CRM) database 1902, a billing database 1904, a service fulfillment database 1906, a data store 1908 of rule data and a data store 1910 for storing catalogue data 1910.

The data access system 1900 applies a group of rules from a ‘catalogue’ category which query the databases 1902, 1904, 1906 and obtain the data relating to the products and services. The resulting data is then written to the catalogue data store 1910, and may be further processed and inserted into a catalogue template, for example. The use of a common model simplifies the task of collating the data from the generally mutually-incompatible databases 1902, 1904, 1906, and the use of the rules allows the catalogue to be generated easily on demand, but also easily to be altered or otherwise customised by changing rules or adding new ones if necessary. Different groups of rules can also be created to generate further, different catalogues of data.

The development process of a new product or service will now be described.

FIG. 20 is a flowchart illustrating a process for creating a new product or service for use with the system of FIG. 2.

The characteristics of the new product or service are first defined (step S2000), and it is determined (step S2002) whether any new attributes (or relationships) of the product or service are required (for example, a new broadband product may require a ConnectionSpeed attribute to be defined for the Product entity). If so, the database structure of the relevant database is updated (step S2004), and the common model is updated to reflect the changes (step S2006) and finally the metamodel is updated (step S2008) is required. New rules are then created (S2010) to provide the relevant validation, evaluation and data access functions. The impact and the cost of the new product or service can then be evaluated (S2012), and the provision of the new product or service is then tested (step S2014), for example by applying the new rules to various test scenarios. If the testing is satisfactory (step S2016), the product or service can then be launched (by enabling the operation of the relevant rules).

The procedure for developing a new product or service does not require any new code to be written or tested, saving a considerable amount of time compared to traditional product/service development cycles.

The rules in the system are subject to version control, such that in the event of a problem with a particular product or service, the relevant rules can be quickly identified and/or withdrawn.

FIG. 21 is a schematic showing an example of the system of FIG. 2 in more detail, showing the integration of a legacy computer system 2100 of a telecommunications operator with a data access system 2120 as described above.

Various hardware and/or software adapters 2110 provide a direct connection between the legacy system 2100 and the data access system 2120, and an EAI/BPM (Enterprise Application Integration/Business Process Management) bus provides a further, standardised, connection. An ESB (Enterprise Service Bus), or other types of adapters may instead be provided. A web interface 2114 provides a user with access to the functionality of the data access system 2120.

The legacy system 2100 includes a customer relations management (CRM) component 2102, a billing component 2104, and a service fulfillment component 2106, each with their own databases, systems and legacy (and other) applications.

The data access system 2120 includes a back-end 2130, largely handling with the interface with the legacy system 2100, and a front-end 2150, largely handling the interface with the user via the web interface 2114.

The back-end 2130 includes various Enterprise Information Integration (EII) components 2132 and a data store 2134 containing a data store for data used internally with the data access system. The EII components include a federated data query/update component 2136 for accessing external data sources and aggregating the data within a common model, a rule management component 2138 for processing the various rules, a security component 2140, and an external services component 2142 for interfacing with external systems. The security component enforces access controls on the various internal and external data sources, for example permitting certain users and/or applications read-only access to certain data, and preventing unauthorised users or applications from accessing any data at all. It will be appreciated that other interconnections between components may exist other than those which have been shown.

The front-end includes a catalogue application 2152, a system development application 2154 and an operational management application 2156. The catalogue application 2152 allows the user to create, edit and execute a query, defined by a set of rules, to create a catalogue of products and services offered by the telecommunications operator, as described above with reference to FIG. 19, for example. The system development application 2154 allows the development of new rules and new products and services as described above with reference to FIG. 20. The operational management application 2156 allows the editing of rules and other functions relating to the current operational performance of the system. Further applications and/or user interfaces may be provided to control the data migration process described above with reference to FIGS. 10 to 12, and to manage further aspects of the system.

The rule classes described above specify metamodel parameters (such as entity and attribute name fields) which rules may provide specific values for. Other types of rules may be provided, for example specifying the content of the rule as an essentially arbitrary text strings, such as a metamodel equivalent of an SQL query. Other class-based and non class-based approaches are of course possible.

The discussion of data migration has been described above with reference to transferring data from one legacy database to one new database. It will of course be appreciated that the system described above can be applied also to a plurality of legacy databases and/or a plurality of new databases using the techniques described herein.

Conversely, it will be appreciated that where the data access system has been described above in relation to a plurality of databases, the system may also be adapted to work with a single database. The term ‘database’ is intended to include any system for storing data in a structured fashion (regardless of how detailed the structure is) or a system which presents an interface to access data in a structured fashion (such as a set of APIs or other access code, or a program such as MetaMatrix (RTM)), and may cover both physical and logical storage devices including, for example, portions of random access memory (RAM, one or more files in a hard disk or other physical storage device, highly distributed data store, and so on. Likewise, the storage means referred to above may include hardware or software devices capable of storing data, such as a hard disk, flash memory, and so on, and may be connected to the relevant processing device(s) locally or via a local- or wide-area network. References to access means may include hardware or software devices capable of interfacing with storage and other devices, and may include physical interfaces and/or software device drivers, for example.

The processing means referred to above may be any hardware or software device capable of processing data, such as one or more CPUs operating within one or more computers or servers, virtual machines executing within a host computer or other device, ASIC or other dedicated hardware, and so on.

Further modifications lying within the spirit and scope of the present invention will be apparent to a skilled person in the art.

1. A system for accessing data stored in at least one database, comprising:
access means for accessing:
model data, representing a model defining the structure of the data;
metamodel data, representing a metamodel defining the structure of the model; and
rule data, representing at least one rule for accessing the data, said at least one rule specifying at least one constraint in terms of a property of the metamodel; and
processing means adapted to process the rule data, and to access the data in said at least one database in dependence on the processed rule data.

2. A system according to claim 1, further comprising receiving means for receiving selection data identifying a rule represented by the rule data, and wherein the processing means is adapted to apply the selected rule.

3. A system according to claim 1, wherein the access means is further adapted to access rule class data representing at least one rule class, each rule class including at least one parameter corresponding to a property of the metamodel, and wherein the rule data includes for said at least one rule an association between the rule and a corresponding rule class, and values for the relevant rule class parameters.

4. A system for accessing data stored in at least one database, comprising:
access means for accessing:
model data, representing a model defining the structure of the data;
metamodel data, representing a metamodel defining the structure of the model; and
rule class data representing at least one rule class, each rule class having at least one parameter corresponding to a property of the metamodel;
input means for inputting a selection of a rule class, and a selection of model data corresponding to at least one parameter associated with the selected rule class; and
processing means for creating new rule data in accordance with the inputted selections.

5. A system according to claim 1, wherein the data is stored in a plurality of databases, and the model defines a data structure covering all of the databases.

6. A system for accessing data stored in at least one database, comprising:
access means for accessing cross-reference data representing cross-references between different portions of the data;
processing means for processing a request to access the data, adapted to retrieve the requested data and cross-reference data corresponding to the requested data; and
output means for outputting the requested data and the cross-reference data corresponding to the requested data.

7. A system for facilitating the migration of data from at least one first database to at least one further database, comprising:
access means for accessing:
data in said at least one first database;
data in said at least one further database; and
receiving means for receiving a request to access data; and
routing means for processing the received request to determine whether the data has been migrated to said at least one further database, and for routing the request accordingly.

8. A database system, comprising:
at least one database containing data; and
storage means for storing:
model data, representing a model defining the structure of the data;
metamodel data, representing a metamodel defining the structure of the model; and
rule data, representing at least one rule for accessing the data, said at least one rule specifying at least one constraint in terms of a property of the metamodel; and
processing means adapted to process the rule data, and to access the data in said at least one database in dependence on the processed rule data.

9. A method of accessing data stored in at least one database, comprising:
accessing:
model data, representing a model defining the structure of the data;
metamodel data, representing a metamodel defining the structure of the model; and
rule data, representing at least one rule for accessing the data, said at least one rule specifying at least one constraint in terms of a property of the metamodel;
processing the rule data, and accessing the data in said at least one database in dependence on the processed rule data.

10. A method according to claim 9, further comprising receiving selection data identifying a rule represented by the rule data, and wherein the step of processing includes applying the selected rule.

11. A method according to claim 9, further comprising accessing the data in said at least one database, and processing the data in accordance with said at least one rule.

12. A method according to claim 11, wherein the step of processing includes selecting data from at least one of said at least one database, and processing the selected data in accordance with the rule data to determine whether the selected data complies with said at least one rule.

13. A method according to claim 12, further comprising updating the selected data so that the selected data complies with said at least one rule.

14. A method according to claim 9, wherein the step of processing includes generating a database query corresponding to at least one selected rule, and the method further comprises outputting the database query.

15. A method according to claim 9, wherein the step of accessing includes accessing rule class data representing at least one rule class, each rule class including at least one parameter corresponding to a property of the metamodel, and wherein the rule data includes for said at least one rule an association between the rule and a corresponding rule class, and values for the relevant rule class parameters.

16. A method according to claim 15, wherein the step of processing includes processing said at least one rule in a manner dependent on the rule class associated with the rule.

17. A method according to claim 15, wherein each rule class has an output type associated with it, and the step of processing includes producing an output for said at least one rule in accordance with the output type specified by the relevant rule class.

18. A method according to claim 9, wherein said at least one rule comprises at least one validation rule, and the step of processing includes generating an output in dependence on whether a constraint specified by said at least one validation rule is complied with.

19. A method according to claim 18, wherein said at least one validation rule specifies a first rule input, a second rule input, and a comparison operator, and the step of processing includes performing a comparison between the first rule input and the second rule input in accordance with the comparison operator.

20. A method according to claim 18, wherein said at least one rule comprises at least one query rule, and the step of processing includes selecting at least one database object matching the constraint specified by said at least one query rule.

21. A method according to claim 20, wherein the step of processing includes applying at least one further rule included in said at least one selected database object.

22. A method according to claim 9, wherein said at least one rule comprises at least one rule including a reference to a plurality of further rules, and the step of processing includes applying the further rules.

23. A method according to claim 22, wherein the step of processing includes applying the further rules in an ordered sequence defined by said at least one rule that includes a reference, and linking preceding further rules and successive further rules in accordance with rule linkage specifiers defined by said at least one rule that includes a reference.

24. A method according to claim 23, wherein the step of processing includes linking preceding further rules and successive rules by performing at least one of the functions of: linking the output of a preceding rule to the input of a successive rule, intersecting the output of a preceding rule and a successive rule, and forming the union of the output of a preceding rule and a successive rule.

25. A method according to claim 9, further comprising receiving at least one parameter, and wherein the step of processing includes processing said at least one rule using said at least one parameter as an input.

26. A method according to claim 9, wherein the rule data includes group data specifying a group membership for at least one rule, and the step of processing includes processing the group data to apply rules belonging to a specified group.

27. A method according to claim 15, wherein the method further comprises:
inputting a selection of a rule class, and for inputting data to populate the rule class; and
creating new rule data in accordance with the inputted class selection and inputted data.

28. A method facilitating access to data stored in at least one database, comprising:
accessing:
model data, representing a model defining the structure of the data;
metamodel data, representing a metamodel defining the structure of the model; and
rule class data representing at least one rule class, each rule class having at least one parameter corresponding to a property of the metamodel;
inputting a selection of a rule class, and a selection of model data corresponding to at least one parameter associated with the selected rule class; and
creating new rule data in accordance with the inputted selections.

29. A method according to claim 28, wherein the step of accessing includes accessing model data, representing a model defining the structure of data stored in said at least one database, and the step of inputting includes inputting data by selecting at least one of entities, attributes and relationships of the model.

30. A method according to claim 28, further comprising outputting version data associated with the new rule data, and wherein the step of processing includes processing the version data to select rules corresponding to a specified version.

31. A method according to claim 9, wherein the data is stored in a plurality of databases, and the model defines a data structure covering all of the databases.

32. A method according to claim 9, further comprising accessing cross-reference data representing cross-references between different portions of the data.

33. A method according to claim 32, further comprising processing the data in the databases to identify links between one portion of the data and another portion of the data, and generating cross-reference data representing the links.

34. A method according to claim 32, further comprising:
processing a request to access the data, including the steps of retrieving the requested data and cross-referencing data corresponding to the requested data; and
outputting the requested data and the cross-reference data corresponding to the requested data.

35. A method of accessing data stored in at least one database, comprising:
accessing cross-reference data representing cross-references between different portions of the data;
processing a request to access the data, including the steps of retrieving the requested data and cross-referencing data corresponding to the requested data; and
outputting the requested data and the cross-reference data corresponding to the requested data.

36. A method according to claim 35, wherein the step of outputting includes combining the requested data and the cross-reference data into a single data set.

37. A method according to claim 9, wherein the step of processing includes processing the rule data to select database objects corresponding to a set of products or services, and processing the selected database objects to generate a list of the products or services.

38. A method according to claim 37, further comprising outputting catalogue data representing a catalogue of products or services, the step of outputting including the step of including the list of products or services in the catalogue data.

39. A method according to claim 38, wherein the step of processing includes selecting product or service description data from a first database and selecting product or service price data from a second database.

40. A method according to claim 9, wherein the step of accessing includes accessing at least one further database for holding data migrated from the plurality of databases, and wherein the method further comprises:
receiving a request to access data; and
processing the received request to determine whether the data has been migrated to said at least one further database, and routing the request accordingly.

41. A method of facilitating the migration of data from at least one first database to at least one further database, comprising:
accessing:
data in said at least one first database;
data in said at least one further database; and
receiving a request to access data; and
processing the received request to determine whether the data has been migrated to said at least one further database, and routing the request accordingly.

42. A method according to claim 41, further comprising transferring data from said at least one first database to said at least one further database.

43. A method according to claim 41, wherein the step of routing includes processing rule data to determine the database to which the request should be routed.

44. A method of performing an operation on data in at least one database, comprising:
passing a request to a system as defined in any one of claims 38 to 72 and receiving an output from the system, the request including a specifier identifying at least one rule corresponding to the operation to be performed, and the output representing the result of applying said at least one rule; and
selectively performing the operation in dependence on the received output.

45. A method of providing a product or service, comprising:
providing a model of data representing aspects of the product or service,
providing a metamodel defining the structure of the model; and
providing at least one rule for accessing the data, said at least one rule imposing a constraint defining characteristics of the product or service.

46. A method according to claim 45, further comprising:
defining characteristics of the new product or service;
analysing the impact and cost of the product or service;
testing the product or service; and
launching the product or service.

47. A method according to claim 46, wherein the step of testing the product or service includes applying said at least one rule to test data and revising at least one of the model, metamodel and said at least one rule in dependence on the result of the testing.

48. A computer system for accessing data stored in at least one database, comprising:
an instruction memory storing processor implementable instructions; and
a processor operable to read and process the data in accordance with instructions stored in the instruction memory;
wherein the instructions stored in the instruction memory comprise instructions for controlling the processor to perform a method comprising:
accessing:
model data, representing a model defining the structure of the data;
metamodel data, representing a metamodel defining the structure of the model; and
rule data, representing at least one rule for accessing the data, said at least one rule specifying at least one constraint in terms of a property of the metamodel; and
processing the rule data, and accessing the data in said at least one database in dependence on the processed rule data.

49. A computer system according to claim 48, wherein the computer system is adapted to receive selection data identifying a rule represented by the rule data, and the instruction memory includes further instructions for controlling the processor to perform the step of applying the selected rule.

50. A computer system according to claim 48, wherein the instruction memory includes further instructions for controlling the processor to perform the steps of accessing the data in said at least one database, and processing the data in accordance with said at least one rule.

51. A computer system according to claim 50, wherein the step of processing includes selecting data from at least one of said at least one database, and wherein the instruction memory includes further instructions for controlling the processor to perform the step of processing the selected data in accordance with the rule data to determine whether the selected data complies with said at least one rule.

52. A computer system according to claim 51, wherein the instruction memory includes further instructions for controlling the processor to perform the step of updating the selected data so that the selected data complies with said at least one rule.

53. A computer system according to claim 48, wherein the step of processing includes generating a database query corresponding to at least one selected rule, and wherein the instruction memory includes further instructions for controlling the processor to perform the step of outputting the database query.

54. A computer system according to claim 48, wherein the step of accessing includes accessing rule class data representing at least one rule class, each rule class including at least one parameter corresponding to a property of the metamodel, and wherein the rule data includes for said at least one rule an association between the rule and a corresponding rule class, and values for the relevant rule class parameters.

55. A computer system according to claim 54, wherein the step of processing includes processing said at least one rule in a manner dependent on the rule class associated with the rule.

56. A computer system according to claim 54, wherein each rule class has an output type associated with it, and the step of processing includes producing an output for said at least one rule in accordance with the output type specified by the relevant rule class.

57. A computer system according to claim 48, wherein said at least one rule comprises at least one validation rule, and the step of processing includes generating an output in dependence on whether a constraint specified by said at least one validation rule is complied with.

58. A computer system according to claim 57, wherein said at least one validation rule specifies a first rule input, a second rule input, and a comparison operator, and the step of processing includes performing a comparison between the first rule input and the second rule input in accordance with the comparison operator.

59. A computer system according to claim 57, wherein said at least one rule comprises at least one query rule, and the step of processing includes selecting at least one database object matching the constraint specified by said at least one query rule.

60. A computer system according to claim 59, wherein the step of processing includes applying at least one further rule included in said at least one selected database object.

61. A computer system according to claim 48, wherein said at least one rule comprises at least one rule including a reference to a plurality of further rules, and the step of processing includes applying the further rules.

62. A computer system according to claim 61, wherein the step of processing includes applying the further rules in an ordered sequence defined by said at least one rule that includes a reference, and linking preceding further rules and successive further rules in accordance with rule linkage specifiers defined by said at least one rule that includes a reference.

63. A computer system according to claim 62, wherein the step of processing includes linking preceding further rules and successive rules by performing at least one of the functions of: linking the output of a preceding rule to the input of a successive rule, intersecting the output of a preceding rule and a successive rule, and forming the union of the output of a preceding rule and a successive rule.

64. A computer system according to claim 48, wherein the instruction memory includes further instructions for controlling the processor to perform the step of receiving at least one parameter, and wherein the step of processing includes processing said at least one rule using said at least one parameter as an input.

65. A computer system according to claim 48, wherein the rule data includes group data specifying a group membership for at least one rule, and the step of processing includes processing the group data to apply rules belonging to a specified group.

66. A computer system according to claim 54, wherein the instruction memory includes further instructions for controlling the processor to perform the steps of:
inputting a selection of a rule class, and for inputting data to populate the rule class; and
creating new rule data in accordance with the inputted class selection and inputted data.

67. A computer system for accessing data stored in at least one database, comprising:
an instruction memory storing processor implementable instructions; and
a processor operable to read and process the data in accordance with instructions stored in the instruction memory;
wherein the instructions stored in the instruction memory comprise instructions for controlling the processor to perform a method comprising:
accessing:
model data, representing a model defining the structure of the data;
metamodel data, representing a metamodel defining the structure of the model; and
rule class data representing at least one rule class, each rule class having at least one parameter corresponding to a property of the metamodel;
inputting a selection of a rule class, and a selection of model data corresponding to at least one parameter associated with the selected rule class; and
creating new rule data in accordance with the inputted selections.

68. A computer system according to claim 67, wherein the step of accessing includes accessing model data, representing a model defining the structure of data stored in said at least one database, and the step of inputting includes inputting data by selecting at least one of entities, attributes and relationships of the model.

69. A computer system according to claim 67, wherein the instruction memory includes further instructions for controlling the processor to perform the step of outputting version data associated with the new rule data, and wherein the step of processing includes processing the version data to select rules corresponding to a specified version.

70. A computer system according to claim 48, wherein the data is stored in a plurality of databases, and the model defines a data structure covering all of the databases.

71. A computer system according to claim 48, wherein the instruction memory includes further instructions for controlling the processor to perform the step of accessing cross-reference data representing cross-references between different portions of the data.

72. A computer system according to claim 71, wherein the instruction memory includes further instructions for controlling the processor to perform the steps of processing the data in the databases to identify links between one portion of the data and another portion of the data, and generating cross-reference data representing the links.

73. A computer system according to claim 71, wherein the instruction memory includes further instructions for controlling the processor to perform the steps of:
processing a request to access the data, including the steps of retrieving the requested data and cross-referencing data corresponding to the requested data; and
outputting the requested data and the cross-reference data corresponding to the requested data.

74. A computer system for accessing data stored in at least one database, comprising:
an instruction memory storing processor implementable instructions; and
a processor operable to read and process the data in accordance with instructions stored in the instruction memory;
wherein the instructions stored in the instruction memory comprise instructions for controlling the processor to perform a method comprising:
accessing cross-reference data representing cross-references between different portions of the data;
processing a request to access the data, including the steps of retrieving the requested data and cross-referencing data corresponding to the requested data; and
outputting the requested data and the cross-reference data corresponding to the requested data.

75. A computer system according to claim 74, wherein the step of outputting includes combining the requested data and the cross-reference data into a single data set.

76. A computer system according to claim 48, wherein the step of processing includes processing the rule data to select database objects corresponding to a set of products or services, and processing the selected database objects to generate a list of the products or services.

77. A computer system according to claim 76, wherein the instruction memory includes further instructions for controlling the processor to perform the step of outputting catalogue data representing a catalogue of products or services, the step of outputting including the step of including the list of products or services in the catalogue data.

78. A computer system according to claim 77, wherein the step of processing includes selecting product or service description data from a first database and selecting product or service price data from a second database.

79. A computer system according to claim 48, wherein the step of accessing includes accessing at least one further database for holding data migrated from the plurality of databases, and wherein the instruction memory includes further instructions for controlling the processor to perform the steps of:
receiving a request to access data; and
processing the received request to determine whether the data has been migrated to said at least one further database, and routing the request accordingly.

80. A computer system for facilitating the migration of data from at least one first database to at least one further database, comprising:
an instruction memory storing processor implementable instructions; and
a processor operable to read and process the data in accordance with instructions stored in the instruction memory;
wherein the instructions stored in the instruction memory comprise instructions for controlling the processor to perform a method comprising:
accessing:
data in said at least one first database;
data in said at least one further database; and
receiving a request to access data; and
processing the received request to determine whether the data has been migrated to said at least one further database, and routing the request accordingly.

81. A computer system according to claim 80, wherein the instruction memory includes further instructions for controlling the processor to perform the step of transferring data from said at least one first database to said at least one further database.

82. A computer system according to any one of claims 80, wherein the step of routing includes processing rule data to determine the database to which the request should be routed.

83. A carrier medium carrying computer readable code for controlling a computer to carry out the method of accessing data stored in at least one database, the method comprising:
accessing:
model data, representing a model defining the structure of the data;
metamodel data, representing a metamodel defining the structure of the model; and
rule data, representing at least one rule for accessing the data, said at least one rule specifying at least one constraint in terms of a property of the metamodel; and
processing the rule data, and accessing the data in said at least one database in dependence on the processed rule data.

84. A carrier medium carrying computer readable code for controlling a computer to carry out the method of facilitating access to data stored in at least one database, the method comprising:
accessing:
model data, representing a model defining the structure of the data;
metamodel data, representing a metamodel defining the structure of the model; and
rule class data representing at least one rule class, each rule class having at least one parameter corresponding to a property of the metamodel;
inputting a selection of a rule class, and a selection of model data corresponding to at least one parameter associated with the selected rule class; and
creating new rule data in accordance with the inputted selections.

85. A carrier medium carrying computer readable code for controlling a computer to carry out the method of accessing data stored in at least one database, the method comprising:
accessing cross-reference data representing cross-references between different portions of the data;
processing a request to access the data, including the steps of retrieving the requested data and cross-referencing data corresponding to the requested data; and
outputting the requested data and the cross-reference data corresponding to the requested data.

86. A carrier medium carrying computer readable code for controlling a computer to carry out the method of facilitating the migration of data from at least one first database to at least one further database, the method comprising:
accessing:
data in said at least one first database;
data in said at least one further database; and
receiving a request to access data; and
processing the received request to determine whether the data has been migrated to said at least one further database, and routing the request accordingly.
